(19) United States
(12) Patent Application Publication
(10) Pub. No.: US 2002/0164037 A1
(43) Pub. Date: Nov. 7, 2002

(54) Sound image localization apparatus and method

(76) Inventor: Satoshi Sekine, Shizuoka-ken (JP)

Correspondence Address: ROGER R. WISE, PILLSBURY WINTHROP, 725 S. FIGUEROA STREET, #2800, LOS ANGELES, CA, 90017, US

(21) Appl. No.: 09/908,906

(22) Filed: Jul. 19, 2001

(30) Foreign Application Priority Data
Jul. 21, 2000 (JP) 2000-220876

(51) Int. Cl. H04R 5/00

(52) U.S. Cl. 381/18; 381/17

(57) ABSTRACT

There are provided a plurality of filter units provided in corresponding relation to a plurality of predetermined directions on a one-to-one basis, and each of the filter units processes an input tone signal with predetermined transfer characteristics peculiar to the predetermined direction corresponding thereto. Each of the filter units processes the tone signal with transfer characteristics for simulating transfer of a sound from the corresponding predetermined direction to left and right ears of a human listener, and thereby outputs processed tone signals corresponding to the left and right ears. Namely, sound image localization is achieved by synthesis of sound components arriving from a plurality of different predetermined directions. Variation of the sound image localization can be controlled by controlling respective levels of input signals to the individual filter units. Direct sound signal and reflected sound signal delayed behind the direct sound signal are input to the individual filter units after having been subjected to respective level control, so that completely-stereophonic sound image localization is accomplished by a combination of the direct sound signals and reflected sound signals.

### BACKGROUND OF THE INVENTION

The present invention relates to sound image localization apparatus and methods for localizing, at a predetermined position, a sound image of a tone output from an electronic musical instrument or audio equipment.

In known electronic musical instruments and audio equipment, tone volumes, tone output timing, etc. of a plurality of (usually, left and right) speakers are controlled so that a human listener can feel as if tones were being generated from a given spacial point, with a view to enhancing realism of the output tones. The “given spacial point” is called a “virtual sound-generating”, and a virtual spacial area where the human listener feels the tones are being generated (i.e., a location of a virtual musical instrument) is called a “sound image”. Generally, personal stereo headset or headphones today are designed to localize a sound image by supplying tones with volumes separately allocated to left and right speakers in a predetermined proportion. Because the headphones are fixedly attached to the head of the listener, the speakers of the headphones would move with the head as the listener moves his or her head, and thus the sound image would also be caused to move with the head and speakers if only the above-mentioned control is performed. To cope with the sound image movement, a sophisticated headphone system has been proposed, for example, in Japanese Patent Laid-open Publication No. HEI-4-44500. The proposed headphone system controls characteristics of tone signals to be fed to the left and right speakers in accordance with detected movement of the listener's head, to thereby prevents the position of the sound image from varying with the head movement. Also proposed is a sound image localization apparatus using FIR filters (Japanese Patent Laid-open Publication No. HEI-10-23600).

More specifically, the above-mentioned headphone system includes filters provided in corresponding relation to the left and right ears of the listener, and performs control to read out parameters of response characteristics corresponding to a current orientation of the headphones so as to set the read-out parameters. For that purpose, there is a need to prestore, in a parameter memory, a multiplicity of parameters corresponding to a great number of virtual sound-generating positions. Thus, the sound image can not be localized accurately unless the parameter memory has a great capacity for storing the multiplicity of parameters, and also it is necessary to re-read out the parameters from the parameter memory each time the listener moves the head. Further, with the above-mentioned sound image localization apparatus, it is difficult to attain optimal sound image localization for different listeners, and a great difference in effect would result depending on the type and characteristics of the headphones used. Further, this prior art sound image localization apparatus can not systematically control the sound image localization and reverberation.

### SUMMARY OF THE INVENTION

In view of the foregoing, it is an object of the present invention to provide a sound image localization apparatus and method which achieve good-quality sound image localization even with a relatively simple construction. For example, the present invention seeks to permit selective adjustment of an effect corresponding a location of a musical instrument and tone-listening space. It is another object of the present invention to provide a technique which facilitates appropriate adjustment of a feeling of sound image localization for each listener and for each type of headphones used.

In order to accomplish the above-mentioned objects, the present invention provides a sound image localization apparatus for receiving an input tone signal and localizing a sound image of the tone signal in a given position, which comprises a plurality of filter units provided in corresponding relation to a plurality of different predetermined directions on a one-to-one basis, each of the filter units processing the tone signal with predetermined transfer characteristics peculiar to the predetermined direction corresponding thereto. Thus, on the basis of a single input tone signal, each of the filter units is allowed to output a tone signal having been subjected to the processing corresponding to one of the plurality of different predetermined directions. Then, sound image localization is accomplished by synthesizing the processed tone signals having undergone the respective processes corresponding to the plurality of different predetermined directions. Namely, certain sound image localization is accomplished through the synthesis of sound components arriving at the ears from the plurality of different predetermined directions. The sound image localization can be readily varied by controlling levels of signals to be input to (or output from) the individual filter units. As a consequence, the present invention achieves good-quality and easily-controllable sound image localization with a relatively simple construction.

Each of the filter units may process the tone signal with transfer characteristics for simulating transfer of a sound from the corresponding predetermined direction to left and right ears of a human listener, and thereby output processed tone signals corresponding to the left and right ears. The sound image localization apparatus of the present invention may further comprise a filter for compensating frequency characteristics of the tone signals output from the filter units. The inventive sound image localization apparatus may further comprise a reflected-sound-signal generation section that generates a reflected sound signal on the basis of the tone signal. The reflected-sound-signal generation section may include a delay section that generates an initial reflected sound signal on the basis of delaying the tone signal, and a filter that generates an attenuated reflected sound signal on the basis of the initial reflected sound signal. The inventive sound image localization apparatus may further comprise a controller that separately controls a level of the tone signal as a direct sound signal and a level of the reflected sound signal generated by the reflected-sound-signal generation section and then supplies the direct sound signal and the reflected sound signal, having been controlled in level, to individual ones of the filter units; in this case, the levels of the tone signal as the direct sound signal and the reflected sound signal are controlled by the controller independently for each of the filter units. In this way, completely-stereophonic sound image localization is accomplished by a combination of the direct sound signal and reflected sound signal.

The present invention may be constructed and implemented not only as the apparatus invention as discussed above but also as a method invention. Also, the present invention may be arranged and implemented as a software program for execution by a processor such as a computer or DSP, as well as a storage medium storing such a program. Further, the processor used in the present invention may comprise a dedicated processor with dedicated logic built in hardware, not to mention a computer or other general-purpose type processor capable of running a desired software program. Furthermore, each of the filter units may be implemented either by dedicated digital filter hardware or by a DSP or other type of processor programmed to carry out predetermined digital filtering processing.

While the embodiments to be described herein represent the preferred form of the present invention, it is to be understood that various modifications will occur to those skilled in the art without departing from the spirit of the invention. The scope of the present invention is therefore to be determined solely by the appended claims.

### BRIEF DESCRIPTION OF THE DRAWINGS

For better understanding of the object and other features of the present invention, its embodiments will be described in greater detail hereinbelow with reference to the accompanying drawings, in which:

FIG. 1 is a block diagram showing an exemplary general setup of a sound image localization apparatus in accordance with a first embodiment of the present invention;

FIGS. 2A and 2B are diagrams explanatory of a sound image localization scheme used in the first embodiment of the sound image localization apparatus;

FIG. 3 is a block diagram showing an exemplary setup of a sound image localization section in the sound image localization apparatus;

FIG. 4 is an external view of headphones to which is applied the sound image localization apparatus of the invention;

FIGS. 5A and 5B are views showing an exemplary construction of an orientation sensor attached to the headphones;

FIG. 6 is a view showing the orientation sensor in an inclined state;

FIGS. 7A-7D are views showing color gradations provided on a spherical magnet unit of the orientation sensor;

FIG. 8 is a diagram showing an exemplary setup of a photosensor provided in the orientation sensor;

FIGS. 9A and 9B are diagrams showing relationship between a color depth detected by the photosensor of the orientation sensor and an azimuth and between the color depth detected by the photosensor and an angle of inclination;

FIG. 10 is a flow chart showing exemplary operation of a coefficient generator section in the sound image localization apparatus;

FIG. 11 is a flow chart also showing exemplary operation of the coefficient generator section;

FIG. 12 is a graph showing frequency characteristic variations in a case where an IIR filter is employed in the sound image localization apparatus;

FIG. 13 is a conceptual diagram showing virtual speaker positions and sound source position in the sound image localization apparatus in accordance with a second embodiment of the present invention;

FIG. 14 is a block diagram showing an example of a basic general setup of the sound image localization apparatus in accordance with the second embodiment;

FIG. 15 is a block diagram conceptually showing a primary data flow in the second embodiment;

FIG. 16 is a block diagram showing functions of a digital sound field processor (DSP) shown in FIG. 14; and

FIG. 17 is a block diagram showing an exemplary setup of a sound image localization control section shown in FIG. 16.

### DETAILED DESCRIPTION OF EMBODIMENTS

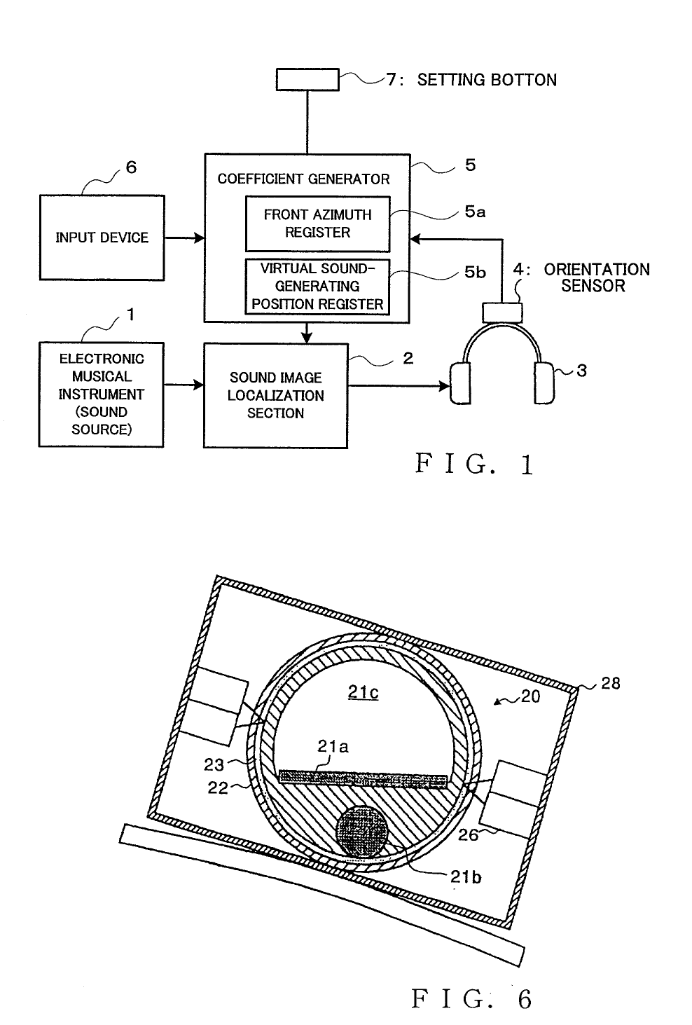

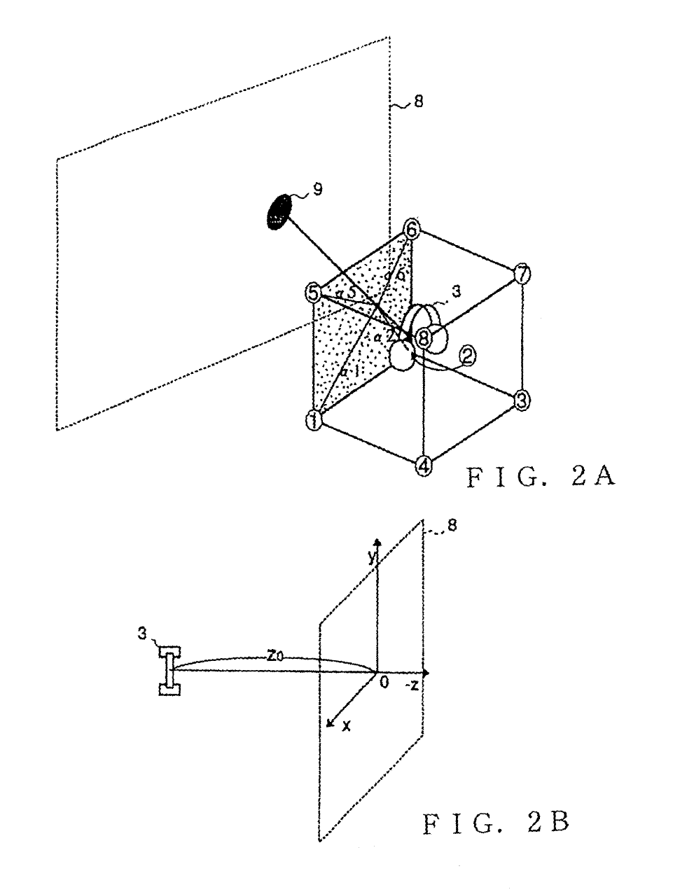

FIG. 1 is a block diagram showing an exemplary general setup of a headphone system which is a first embodiment of the present invention. This headphone system is arranged to supply each tone signal, generated by an electronic musical instrument 1 as a tone source, to personal stereo headphones or headset 3 via a sound image localization section 2. Orientation sensor 4 is provided at the top of the headphones 3, and it permits detection of a direction in which the headphones 3 and hence a human listener putting on the headphones 3 are facing (hereinafter referred to as an “orientation”). Detected data of the orientation sensor 4 are given to a coefficient generator section 5. To the coefficient generator section 5 are connected an input device 6 including, for example, a joystick controller, and a setting button 7. The input device 6 is used by a user to designate a virtual sound-generating position of a tone generated by the electronic musical instrument 1. The virtual sound-generating position is set as an absolute position in a listening space rather than a relative position to the headphones 3 attached to and moving with the listener. The setting button 7 is used for setting a bearing angle (or azimuth) of the headphones 3 when the listener wearing the headphones 3 faces a later-described virtual wall surface 8 (FIG. 2) (with magnetic north as zero degree). The coefficient generator section 5 includes a front azimuth register 5a and virtual sound-generating position register 5b provided in corresponding relation to these operators.

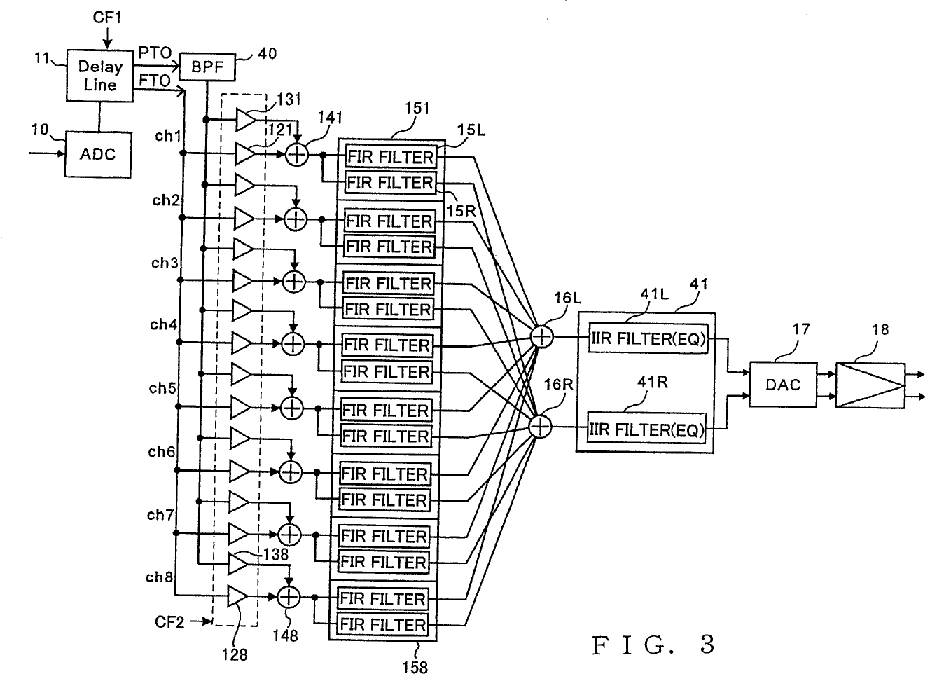

FIGS. 2A and 2B are diagrams explanatory of a sound image localization scheme used in the first embodiment of the invention, and FIG. 3 is a block diagram showing an exemplary setup of the sound image localization section 2 in the first embodiment. In FIG. 3, the sound image localization section 2 includes FIR filters 151-158 for eight channels Ch1-Ch8. These eight channels Ch1-Ch8 correspond to eight different directions \mathring{1}-\mathring{8} shown in FIG. 2A. Namely, the FIR filter 151 for the channel Ch1 includes an FIR filer for left ear 15L and an FIR filer for right ear 15R, and these filters 15L and 15R function to perform arithmetic operations for superposing (or convoluting) tone signals on each other with characteristics of tone transfer from the \mathring{1} direction (position) of FIG. 2A to the left and right ears (HRTFs: Head Related Transfer Functions).

Similarly, the FIR filters 152-158 for the other channels Ch2-Ch8 include pairs of left-ear FIR filers and right-ear FIR filers which function to perform arithmetic operations for superposing tone signals on each other with characteristics of tone transfer from the \mathring{2}-\mathring{8} directions (positions) to the left and right ears. As may be clear from the foregoing, \mathring{1}-\mathring{8} in FIG. 2A represent directions relative to the front of the listener, i.e. the headphones 3, and thus these directions (positions) \mathring{1}-\mathring{8} vary as the listener changes the orientation of his or her head (namely, as the headphones 3 are moved).

Note that the \mathring{1}-\mathring{8} directions represent directions that are necessary for establishing three-dimensional directions, i.e. all-directional bearings, relative to the headphones 3 in a case where the headphones 3 are regarded as a single point. That is, the \mathring{1}-\mathring{8} directions permit establishment of four different directions in each of six different planes: front and rear planes; up and down planes; and left and right planes, relative to the point of the headphones 3. More specifically, the \mathring{1}, \mathring{2}, \mathring{5} and \mathring{6} directions establish four different directions in relation to the front plane of the headphones 3, the \mathring{3}, \mathring{4}, \mathring{7} and \mathring{8} directions establish four different directions in relation to the rear plane of the headphones 3, the \mathring{5}, \mathring{6}, \mathring{7} and \mathring{8} directions establish four different directions in relation to the upper plane of the headphones 3, the \mathring{5}, \mathring{6}, \mathring{7} and \mathring{8} directions establish four different directions in relation to the lower plane of the headphones \mathring{1}, \mathring{2}, \mathring{3} and \mathring{4} directions establish four different directions in relation to the left plane of the headphones 3, and the \mathring{2}, \mathring{3}, \mathring{6} and \mathring{7} directions establish four different directions in relation to the right plane of the headphones 3. In the illustrated example of FIG. 2A, the front of the headphones 3 faces the virtual sound-generating position 9, and the \mathring{1}, \mathring{2}, \mathring{5} and \mathring{6} directions represent directions directly facing the virtual sound-generating position 9.

The above-mentioned input device 6 is, as noted earlier, an operator for designating a virtual sound-generating position of a tone generated by the electronic musical instrument 1. In FIG. 2B, the virtual sound-generating position is shown as localized at a single point on the virtual wall surface 8 which is at a distance of “z0” from the headphones 3, and coordinates on the wall surface 8 are represented by the x and y coordinates with the origin point defined by an intersection between the wall surface 8 and a perpendicular extending from the headphones 3 at the right angle to the wall surface 8.

As the input device 6, for example, in the form of a joystick controller, is manipulated rightward, the x coordinate value of the virtual sound-generating position increases, while as the input device 6 is manipulated leftward, the x coordinate value of the virtual sound-generating position decreases. Similarly, as the input device 6 is manipulated upward, the y coordinate value of the virtual sound-generating position increases, while as the input device 6 is manipulated downward, the y coordinate value of the virtual sound-generating position decreases.

In the illustrated example of FIG. 2A, the virtual sound-generating position is set at the point 9 on the virtual wall surface 8, and the front of the headphones 3 faces the virtual wall surface 8. The virtual sound-generating position forms angles α1, α2, α5 and α6 relative to the \mathring{1}, \mathring{2}, \mathring{5} and \mathring{6} directions of the above-mentioned eight basic directions \mathring{1}\mathring{8}. Thus, gain multipliers 121 and 131 for the channels Ch1, Ch2, Ch5 and Ch6 of FIG. 3 are supplied with gains corresponding to the angles α1, α2, α5 and α6 such that primarily a direct sound (preceding sound) is taken in, while gain multipliers 121 and 131 for the other channels Ch3, Ch4, Ch7 and Ch8 are supplied with gains such that primarily an initial reflected sound (preceding sound) off the virtual wall surface 8 is taken in. In this way, the sound image in the headphones 3 can be localized at the point 9.

As the orientation of the headphones 3 changes, the angles between the point 9 and the headphones 3 vary. Thus, the angles relative to the basic directions are re-calculated, and new gains corresponding to the re-calculated angles are also determined. Therefore, no matter which direction the listener wearing the headphones 3 faces, the sound image can remain localized at the absolute virtual sound-generating position 9 in the listening space.

Note that when the input device 6 is manipulated to compulsorily move the virtual sound-generating position 9, the angles α1, α2, α5 and α6 are re-calculated in response to the manipulation, so that the sound image localized position is moved.

The foregoing paragraphs have only described the case where the virtual sound-generating position 9 faces the front of the headphones 3. When the orientation of the headphones 3 relative to the virtual wall surface 8 has changed in such a manner that the virtual sound-generating position 9 faces the left side of the headphones 3, the \mathring{1}, \mathring{2}, \mathring{5} and \mathring{8} directions become the directions of the direct sound, so that angles α1, α4, α5 and α8 corresponding to the channels Ch1, Ch4, Ch5 and Ch8 are calculated to determine corresponding gains. Similarly, when the orientation of the headphones 3 relative to the virtual wall surface 8 has changed in such a manner that the virtual sound-generating position 9 faces the right side of the headphones 3, the \mathring{2}, \mathring{3}, \mathring{6} and \mathring{7} directions become the directions of the direct sound, so that angles at α2, α3, α6 and α7 corresponding to the channels Ch2, Ch3, Ch6 and Ch7 are calculated to determine corresponding gains.

Further, when the orientation of the headphones 3 relative to the virtual wall surface 8 has changed in such a manner that the virtual sound-generating position 9 faces the back of the headphones 3, the \mathring{3}, \mathring{4}, \mathring{7} and \mathring{8} directions become the directions of the direct sound, so that angles α3, α4, α7 and α8 corresponding to the channels Ch3, Ch4, Ch7 and Ch8 are calculated to determine corresponding gains. Further, when the orientation of the headphones 3 relative to the virtual wall surface 8 has changed in such a manner that the virtual sound-generating position 9 faces the top of the headphones 3, the \mathring{5}, \mathring{6}, \mathring{7} and \mathring{8} and (a directions become the directions of the direct sound, so that angles α5, α6, α7 and α8 corresponding to the channels Ch5, Ch6, Ch7 and Ch8 are calculated to determine corresponding gains. Furthermore, when the orientation of the headphones 3 relative to the virtual wall surface 8 has changed in such a manner that the virtual sound-generating position 9 faces the bottom of the headphones 3, the \mathring{1}, \mathring{2}, \mathring{3} and \mathring{4} directions become the directions of the direct sound, so that angles α1, α2, α3 and α4 corresponding to the channels Ch1, Ch2, Ch3 and Ch4 are calculated to determine corresponding gains.

Note that whereas the instant embodiment has been shown and described as being capable of variably setting the virtual sound-generating position 9 only one virtual wall surface 8, the virtual sound-generating position 9 may be variably set at any other desired point in the listening space. In such a case, the input device 6 is implemented by a device capable of setting three-dimensional coordinates, such as a three-dimensional joystick controller.

The input device 6 for setting and inputting the virtual sound-generating position 9 may comprise other than the joystick controller, such as a joystick-like operator for increasing/decreasing the coordinate values, a ten-button keypad for directly entering coordinate values, a rotary encoder or slider. Further, the virtual sound-generating position 9 may be graphically set in a picture of the wall surface and listening space displayed on a monitor. In addition, the setting switch 7 for setting an orientation of the headphones 3 relative to the virtual wall surface 8 may also be graphically set.

Now, a fuller description will be made about the setup of the sound image localization section 2. The sound image localization section 2 includes an A/D converter 10, a delay line 11, a band-pass filter (BPF) 40, gain multipliers 121-128, gain multipliers 131-138, adders 141-148, FIR filters 151-158, an IIR filter 41, adders 16L and 16R, a D/A converter 17, and an amplifier 18.

Analog tone signal input from the electronic musical instrument 1 is first converted via the A/D converter 10 into a digital signal. However, in a case where the electronic musical instrument 1 is a digital musical instrument that outputs each tone signal in digital form, the A/D converter 10 may be dispensed with so that each tone signal from the electronic musical instrument 1 is directly input to the delay line 11. Note that the input tone signal may be any type of audio signal instead of being limited to one generated by the electronic musical instrument 1.

Although not specifically shown, the delay line 11, in effect, comprises multi-stage shift registers that sequentially shift the input digital tone signal. Two taps (ports for taking out delayed outputs) which will be called a “preceding sound tap” and a “succeeding sound tap”) are provided at two desired positions of the delay line 11, via which delayed signals (preceding sound signal and succeeding sound signal) are taken out.

The positions of the preceding sound tap and succeeding sound tap on the delay line 11 are determined by tap position coefficients CF1 generated by the coefficient generator section 5. The signal taken out or extracted via the preceding sound tap closer to the input terminal of the delay line 11 will be called a preceding sound PTO, while the signal taken out or extracted via the succeeding sound tap remoter from the input terminal of the delay line 11 will be called a succeeding sound FTO. In this instance, the preceding sound PTO corresponds to the direct sound, while the succeeding sound FTO corresponds to the initial reflected sound. As a modification, the tap position coefficients CF1 may be set independently for each of the channels CHI-Ch8 and for each of the preceding and succeeding sounds PTO and FTO, and the preceding and succeeding sounds PTO and FTO may be taken out on a channel-by-channel basis.

The preceding sounds PTO of the individual channels are given to the gain multipliers 121-128 provided in corresponding relation to the channels, and similarly the succeeding sounds FTO of the individual channels are given to the gain multipliers 131-138 provided in corresponding relation to the channels after having been processed via the band-pass filter 40. By appropriately setting the positions (namely, delay amounts) of the two taps on the delay line 11 and the gains to be applied to the gain multipliers 121-128 and 131-138, it is possible to control a feeling of distance and a feeling of depth (in the front-and-back direction) of the sound image. Gain coefficients CF2 are also generated by the coefficient generator section 5.

The band-pass filter (BPF) 40 is provided for simulating attenuation, caused by reflection, on the basis of the succeeding sound signal FTO that represents the initial reflected sound.

For example, if the distance between the two taps is reduced to decrease a timewise deviation between the preceding and succeeding sounds, the feeling of distance will be reduced so that the sound image can be localized at a position closer to the listener. Conversely, if the distance between the two taps is increased to increase a timewise deviation between the preceding and succeeding sounds, the feeling of distance will be increased so that the sound image can be localized at a position remoter from the listener. However, the timewise deviation between the preceding and succeeding sounds should be less than a predetermined value, such as 20 ms, because the deviation exceeding the predetermined value (e.g., 20 ms) would cause the listener to perceive the preceding and succeeding sounds as entirely different sounds.

Further, if a level difference between the preceding and succeeding sounds (i.e., gain difference between the gain multipliers 121-128 for the preceding sound and the the gain multipliers 131-138 for the succeeding sound) is increased, the sound image tends to be localized more forward, while if the level difference between the preceding and succeeding sounds is decreased, the sound image tends to be localized more rearward.

Gain coefficients to be applied to the individual gain multipliers 121-128 and 131-138 for the individual channels Ch1-Ch8 are supplied from the coefficient generator section 5. The preceding and succeeding sound signals multiplied with the respective gain coefficients are added together via adders 141-148 for the channels Ch1-Ch8 on the channel-by-channel basis, and then passed to corresponding FIR filters 151-158. The reason why each input tone signal is delayed to generate preceding and succeeding sound signals is that the same tone signal can be heard at slightly different time points (i.e., with a slight time difference) and this time difference, along with the level difference therebetween can produce a feeling of distance and a feeling of depth in the front-and-rear direction. The FIR filters 151-158, on the other hand, are intended to produce a stereophonic effect perceivable by the listener's left and right ears.

The FIR filter 151 for one of the channels Ch1 includes filters 15L and 15R for left and right ears provided in parallel with each other. The left-ear filter 15L for the channel Ch1 simulates, in accordance with the head related transfer function, a sound when a particular tone arrives at the left ear from the (I direction of FIG. 2A, and the right-ear filter 15R for the channel Ch1 simulates, in accordance with the head related transfer function, a sound when the tone arrives at the right ear from the \mathring{1} direction of FIG. 2A. Similarly, the FIR filters for the other channels Ch2-Ch8 include filters 15L and 15R for left and right ears, which simulate, in accordance with the head related transfer functions, transfer of the tone when the tone arrives at the left and right ears from the \mathring{2}-\mathring{8} directions, respectively, of FIG. 2A. Thus, the head related transfer function characteristics set in the individual FIR filters 151-158 differ depending on the directions.

Also, depending on relative directional or positional relationship between the virtual sound-generating position 9 and the \mathring{1}-\mathring{8} basic directions, the coefficient generator section 5, as shown in FIG. 2A, defines four directions forming a plane facing the virtual sound-generating position 9, and then calculates relative angles of the virtual sound-generating position 9 to the defined four directions. Then, the coefficient generator section 5 supplies the delay line 11 and the gain multipliers 121-128 and 131-138 for the individual channels with such coefficients that determine gains and positions of the taps (i.e., delay amounts) corresponding to the calculated angles. Note that where the tone volume is not to be changed even when the sound image localized position in the headphones 3 has changed, a logarithmic sum of the gains to be applied to the gain multipliers 121-128 and 131-138 is set to be “1”; however, in this case, a special effect may be produced by varying the sum of the gains on the basis of the sound image localized position.

Output signals from the left-ear FIR filters 15L for the individual channels are additively synthesized via an adder 16L, while output signals from the right-ear FIR filters 15L for the individual channels are additively synthesized via an adder 16R. The digital tone signals thus additively synthesized are given to the IIR filters 41L and 41R, respectively.

The IIR filters 41L and 41R are provided for compensating characteristics of the respective additively-synthesized digital tone signals. The FIR filters preceding the IIR filter 41L and 41R have very short response lengths and hence coarse frequency resolutions, so that their characteristics particularly in low frequencies tend to differ from desired characteristics. However, the IIR filter 41L and 41R can compensate the frequency characteristics. Further, although the HRTF characteristics of the FIR filters 151-158 differ among individual listeners, the use of the succeeding IIR filters 41 can compensate for difference in respective tastes or preference of individual listeners and difference in localization characteristics (particularly, in a feeling of vertical localization).

FIG. 12 is a diagram showing frequency characteristic variations in the case where the IIR filters 41 are employed. By passing the additively-synthesized digital signal through the IIR filter 41 as denoted by dotted line, tone signals in high and low frequency bands can be boosted as depicted by an upward arrow, and tone signals in an 8 kHz frequency region, for example, can be dipped. By thus boosting the tone signals in high and low frequency bands, it is possible to compensate the frequency characteristics of the headphones 3 and meet the tastes or preference of the individual listeners. Further, by thus dipping the tone signals in the 8 kHz frequency region, the localization characteristics (particularly, in the feeling of vertical localization) can be adjusted. The dipping in the 8 kHz frequency region can reduce noise components caused on the basis of the inherent structure of the human being's head and thus improve the localization characteristics.

The tone signals in high and low frequency bands are boosted in the illustrated example of FIG. 12; in an alternative, however, the IIR filters 41 may cut off such tone signals in high and low frequency bands. Further, the dipping frequency is not limited to 8 kHz, and the 8 kHz may be finely adjusted to compensate for HRTF differences among individual human listeners.

The tone signals compensated by the IIR filters 41 are each converted via a D/A converter (DAC) 17 into an analog signal, which is then amplified by an amplifier 18 and output to the headphones 3.

In FIG. 3, the multipliers, adders, filters, etc. for the individual channels may be implemented by time-divisionally sharing common hardware. It should also be appreciated that the gain control may be performed on the output side, rather than the input side, of the FIR filters.

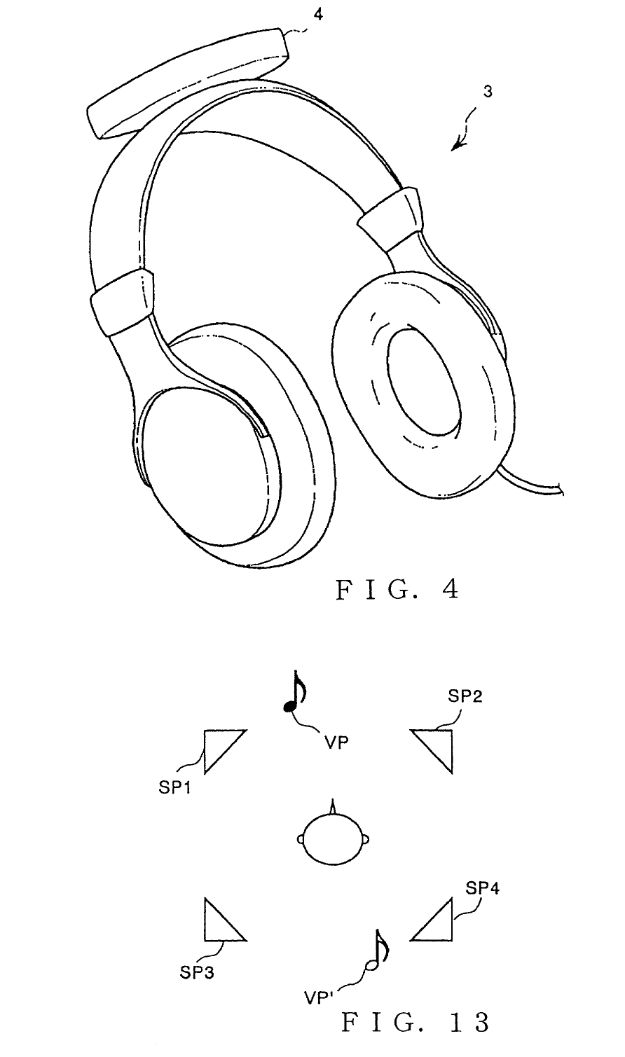

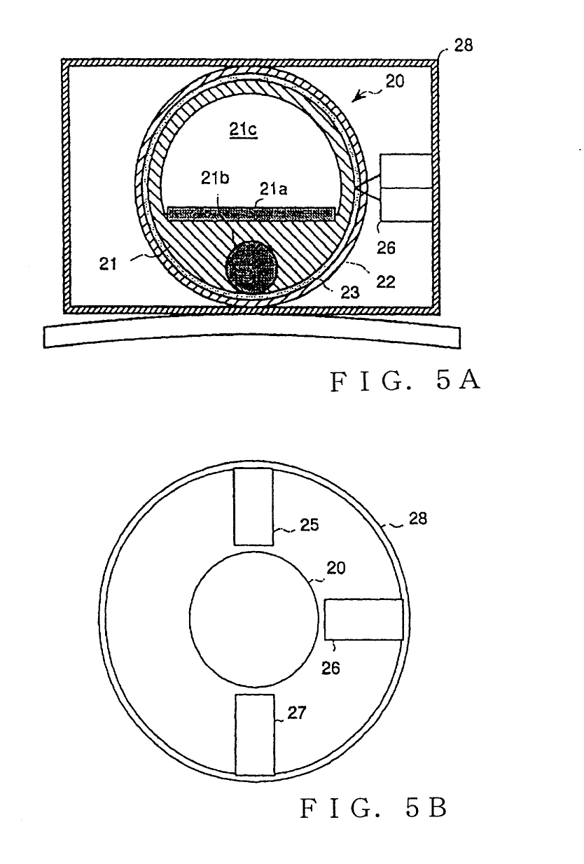

FIG. 4 is an external view of an example of the headphones 3, and FIG. 5 is a view showing an exemplary construction of the orientation sensor 4 attached to the top of the headphones 3. In both ear pad portions of the headphones 3, there are provided small-size speakers to which are input the left and right analog tone signals from the amplifier 18. The orientation sensor 4 is provided at the top of an arched band portion of the headphones 3. The orientation sensor 4 is accommodated within a cylindrical case 28, and it includes a compass 20 and photosensors 25, 26 and 27 as shown in FIG. 5B.

As shown in FIG. 5A, the compass 20 includes a spherical transparent case 22 formed of acrylic resin, a spherical magnet unit 21 accommodated within the transparent case 22, and a liquid 23 filling a gap between the outer surface of the spherical magnet unit 21 and the inner surface of the transparent case 22. The filling liquid 23 is colorless and transparent. The spherical magnet unit 21 is floating in the liquid 23 within the transparent case 22 in such a manner that the magnet unit 21 can rotate and swing within the case 22 freely without friction.

To constantly maintain a predetermined vertical positional relationship relative to the gravity and point to the north-and-south direction in the liquid 23, the spherical magnet unit 21 includes a plate-shaped magnet 21a located in a central region of the magnet unit 21, a hollow space 21c located upwardly of the plate-shaped magnet 21a, and a weight 21b disposed downwardly of the plate-shaped magnet 21a. As shown, for example, in FIG. 6, no matter to which direction the compass 20, i.e. the headphones 3, has turned or no matter how the compass 20 i.e. the headphones 3, has tilted, the plate-shaped magnet 21a and weight 21b swing within the transparent case 20 in such a manner that a particular portion of the magnet 21a always points to the north by virtue of the terrestrial magnetism and the weight 21b always faces in the direction of the gravity.

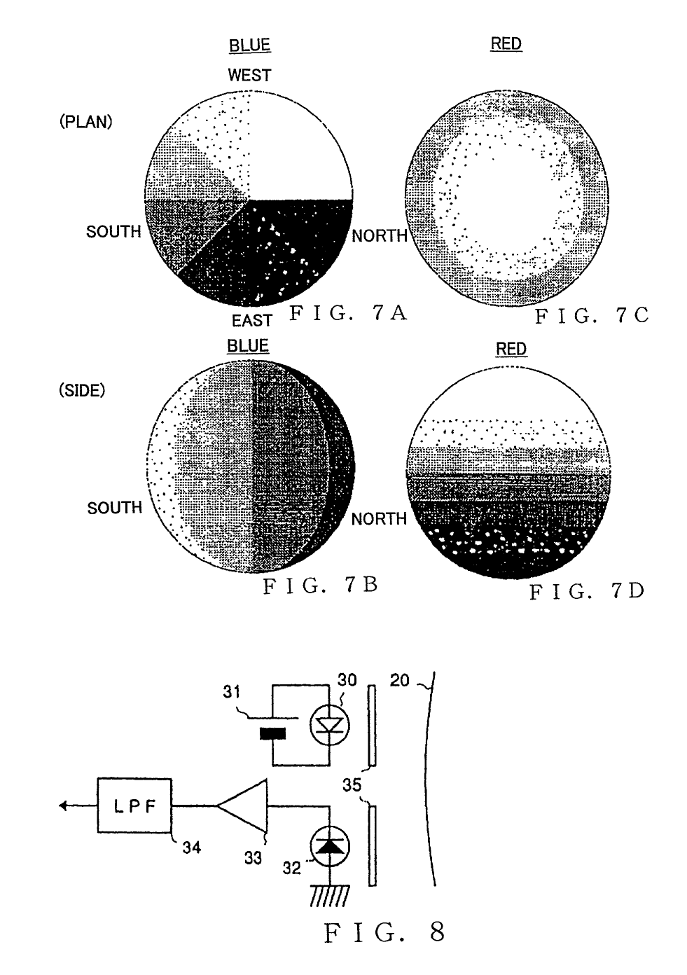

As illustrated in FIGS. 7A and 7D, the outer surface of the spherical magnet unit 21 is colored with blue and red gradations. As shown by a plan view of FIG. 7A and a side view of FIG. 7B, the blue gradation is provided longitudinally such that the strength or depth of the blue color indicates a bearing angle or azimuth; that is, the depth of the blue color becomes smaller in a direction of north→east→south→west→north. More specifically, the changing depth (lightness) of the blue gradation indicates changing azimuths (angles in the clockwise direction with due north as zero degree). Further, as shown by a plan view of FIG. 7C and a side view of FIG. 7D, the red gradation is provided latitudinally such that the strength or depth of the red color indicates an angle of inclination; that is, the greater depth of the red color appears as the transparent case 20 tilts more downward.

In effect, these blue and red gradations are provided mixedly on the same spherical outer surface of the spherical magnet unit 21.

As further illustrated in FIG. 5B, the three photosensors 25 to 27 are disposed, for example, on the inner surface of the cylindrical case 28 in opposed relation to the peripheral surface of the compass 20. The photosensor 25 detects the depth of the blue color, and the photosensors 26 and 27 detect the depth of the red color. More specifically, the photosensor 25 is directed from the front of the headphones 3 toward the peripheral surface of the compass 20, the photosensor 26 is directed from the right side of the headphones 3 toward the peripheral surface of the compass 20, and the photosensor 27 is directed from the back of the headphones 3 toward the peripheral surface of the compass 20.

FIG. 8 is a diagram showing an exemplary setup of one of the above-mentioned photosensors 25, 26 and 27; note that the photosensors 25, 26 and 27 are substantially identical in construction to each other, and hence the construction of only one of the photosensors 25, 26 and 27 is illustrated here representatively. LED 30 and photodiode 32 are provided in opposed relation to the outer surface of the compass 20. Optical filters are provided in front of the LED 30 and photodiode 32 for allowing only a predetermined color to pass therethrough. The LED 30 is continuously driven via a cell 31 to emit light, so as to keep illuminating the outer surface of the spherical magnet unit 21 constituting the compass 20. Resistance value of the photodiode 32 is varied by the photodiode 32 receiving a reflection, off the surface of the spherical magnet unit 21, of the light irradiated by the LED 30.

The photodiode 32 is coupled to an amplifier 33, and the amplifier 33 amplifies a detected value output from the photodiode 32 and passes the amplified detected value to a low-pass filter (LPF) 34. The low-pass filter (LPF) 34 extracts a component of the detected value which corresponds only to movement of the listener's head by eliminating a component corresponding to subtle vibrating movement of the listener's head, and outputs the extracted component to the coefficient generator section 5.

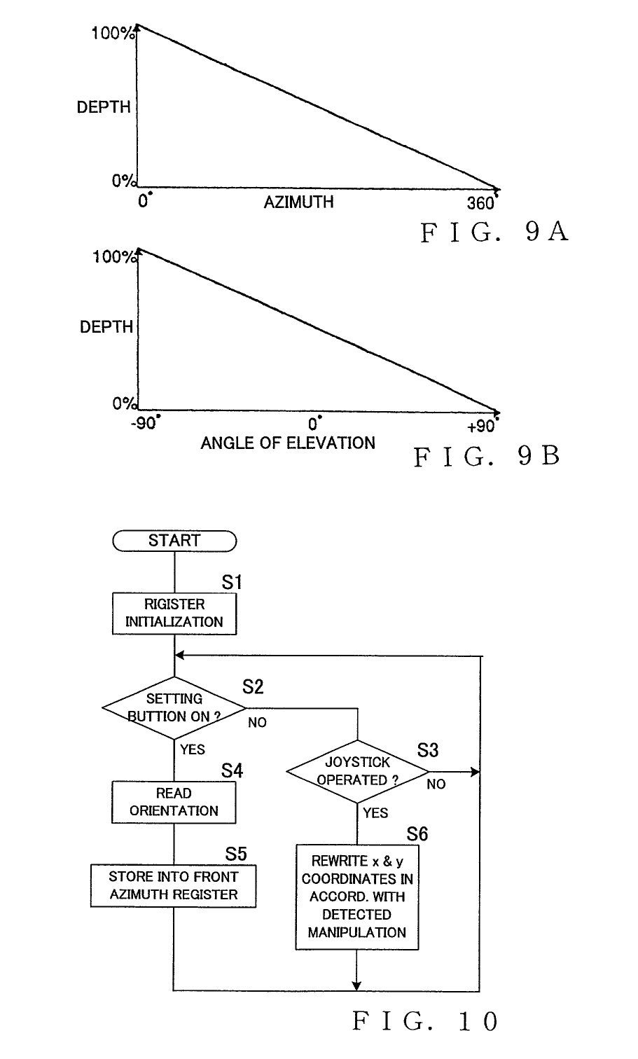

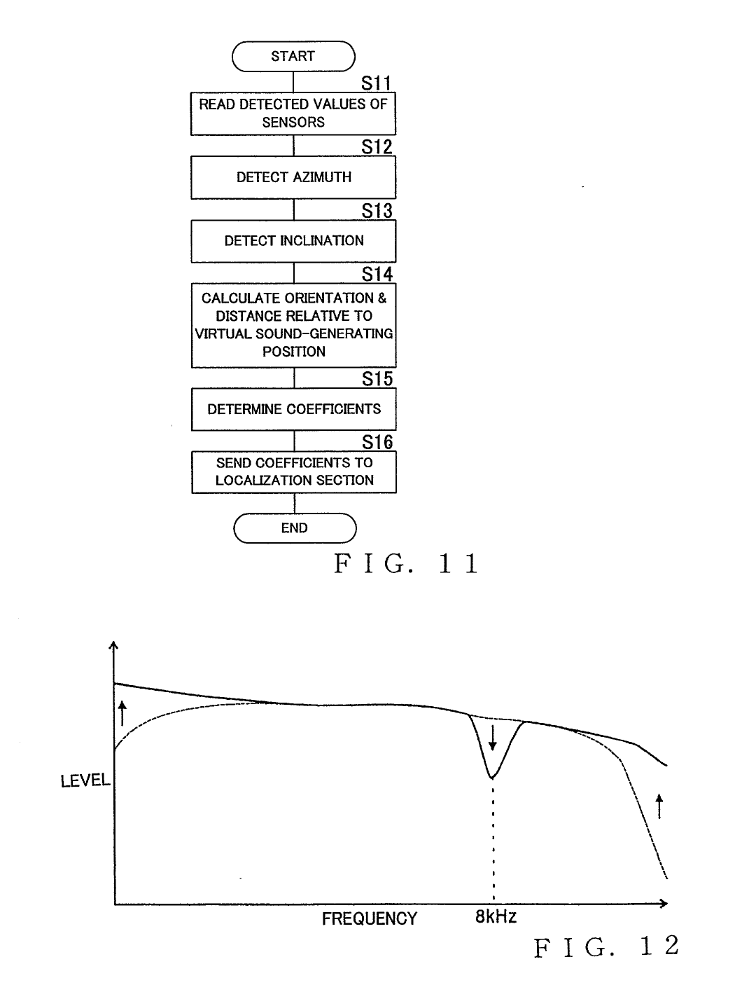

By the photosensor 25 detecting the depth of the blue color on the front surface of the spherical magnet unit 21 of the compass 20, it is possible to detect in which azimuth the headphones 3 are, on the basis of relationship between the detected depth of the blue color and the azimuth angle as shown in FIG. 9A. Further, by the photosensor 26 detecting the depth of the red color on the right side surface of the spherical magnet unit 21, it is possible to detect how much the headphones 3 are inclined to the right on the basis of relationship between the detected depth of the red color and the angle of inclination (angle of elevation) as shown in FIG. 9B. Furthermore, by the photosensor 27 detecting the depth of the red color on the back of the spherical magnet unit 21, it is possible to detect how much the headphones 3 are inclined upward on the basis of relationship between the detected depth of the red color and the angle of inclination (angle of elevation) as shown in FIG. 9B.

The detected data of the photosensors 25 to 27 are input to the coefficient generator section 5, so that the generator section 5 can arithmetically determine, in a three-dimensional manner, a direction and distance of the virtual sound-generating position, set via the input device 6, relative to the headphones 3. The coefficient generator section 5 also calculates the positions of the taps on the delay line 11 (delay amounts) and coefficients of gains of the gain multipliers 12 and 13 for the individual channels Ch1-Ch8 which are intended for realizing the direction and distance of the virtual sound-generating position through signal processing, and outputs the calculated tap positions and coefficients to the sound image localization section 2.

Note that by the use of the terrestrial magnetism sensor as the orientation sensor 4, the instant embodiment can afford the following advantages as compared to other types of sensors such as a gyrosensor. Because no deviation or error would occur even when the listener inclines and turns his or her head, the instant embodiment achieves stable sound image localization even when it is employed in headphones of an electronic piano that is played by the human player frequently moving the upper part of his or her body. Further, due to the fact that the terrestrial magnetism is always stable, calibrating only once a positional relationship (positional settings) between the inventive sound image localization apparatus and an electronic musical instrument or AV equipment functioning as a sound source will suffice. That is, there arises no need to re-calibrate the positional relationship when the user is about to start actually using the sound image localization apparatus or during the use of the localization apparatus, until the sound image localization apparatus is removed and installed in another place. Furthermore, the terrestrial magnetism sensor employed in the instant embodiment is inexpensive as compared to other types of orientation sensors such as a gyrosensor.

Further, the instant embodiment can appropriately be adjust in its response to rotation of the listener's head, by adjusting the tenacity of the liquid in which the orientation-finding magnet is floating. The detected data of the compass may be transmitted to the coefficient generator section 5 either by wired transmission or by wireless transmission. In the case where the detected data of the compass are transmitted to the coefficient generator section 5 by wireless transmission, the cell used as the power supply may be of a rechargeable type. For example, a holder on which the headphones are hung or held when not in use may have the recharging function so that the cell can be recharged while the headphones are held in place on the holder. Further, in the case where the detected data of the compass are transmitted to the coefficient generator section 5 by wired transmission, signals and electric power may be transmitted and received via an audio cable of the headphones.

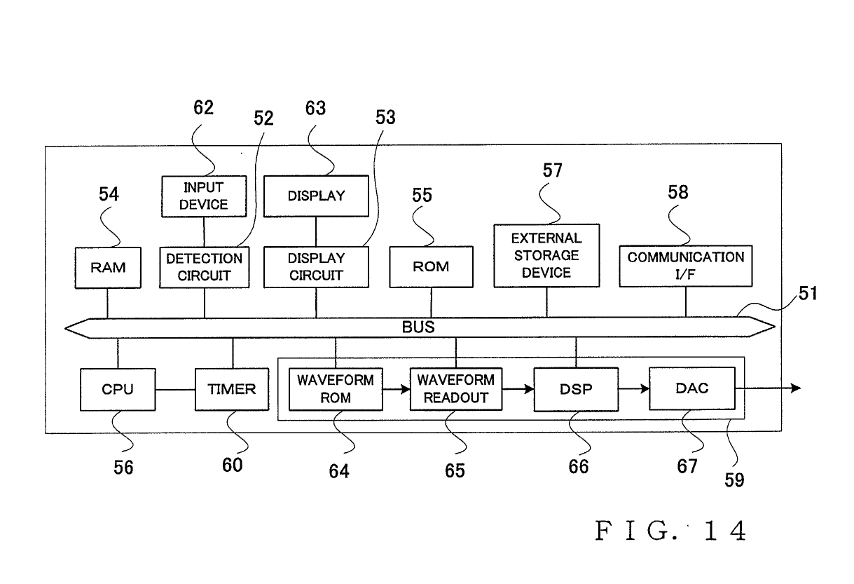

FIGS. 10 and 11 are flow charts showing exemplary operation of the coefficient generator section 5. Upon start of the operation, various registers are initialized at step S1. Specifically, zero degree is set in the front azimuth register 5a ; that is, it is assumed that the front (virtual wall surface 8) of the headphones 3 faces due north. Also, a value “0” is set as x and y coordinates into the virtual sound-generating position register 5b. Namely, settings are made as if the virtual sound-generating position were right in front of the headphones 3. After the initialization at step S1, the coefficient generator section 5 is placed in a standby state until the setting button 7 is turned on (step S2) or the input device 6 is operated (step S3). Once the setting button 7 is turned on as determined at step S2, the orientation being currently detected by the orientation sensor 4 (value detected by the photosensor 25) is read at step S4, and the thus-read orientation is stored into the front azimuth register 5a at step S5. On the other hand, once the input device 6 is operated as determined at step S3, the x and y coordinates stored in the virtual sound-generating position register 5b are rewritten, at step S6, in accordance with the detected manipulation of the input device 6. Namely, as the input device 6 is manipulated rightward or leftward, the x coordinate value of the virtual sound-generating position is caused to increase or decrease. As the input device 6 is manipulated upward or downward, the y coordinate value of the virtual sound-generating position is caused to increase or decrease.

FIG. 11 shows an example of a timer interrupt process, which is a localized position control process executed once for every several tens of milliseconds. First, the currently detected values of the three photosensors 25, 25 and 27 contained in the orientation sensor 4 are read at step S11. Then, the current orientation, azimuth and inclination, of the headphones 3 are detected, at steps S12 and S13, on the basis of the thus-read detected values of the three photosensors 25, 25 and 27. Then, at following step S14, an orientation and distance of the headphones 3 relative to the virtual sound-generating position are calculated on the basis of the detected orientation and inclination, data currently stored in front azimuth register 5a, and distance z0 and x and y coordinate values of the virtual sound source. Further, gain coefficients to be applied to the individual channels and coefficients of tap positions (delay amounts) of the delay lines 11 are determined, at step S15, on the basis of the orientation and distance of the headphones 3 relative to the virtual sound-generating position, and the thus-determined gain coefficients and coefficients of tap positions (delay amounts) are given to the sound image localization section 2 at step S16.

Note that the gain coefficients to be applied to the individual channels and tap positions of the delay lines 11 may be determined using predetermined mathematical expressions based on the calculated orientation and distance, or by reading out suitable coefficients from among many coefficients that are prestored in a coefficient table in corresponding relation to various possible orientations and distances. Quantity of data stored in this coefficient table can be greatly reduced as compared to another possible type of table where are stored transfer characteristic parameters of FIR filters corresponding to a plurality of orientations and distances, and the coefficient table may have a smaller storage capacity.

Now, a description will be made about a second embodiment of the present invention. Although the first embodiment of the present invention has been described above as establishing eight virtual sound image positions using the sensor-equipped headphones, the first embodiment can not provide an inexpensive system as long as the described construction is employed. Thus, the second embodiment is constructed to establish four virtual sound image positions (virtual speaker positions) using the conventional headphones. For convenience of description, let it be assumed here that the human listener faces straight ahead with the orientation of the headphones held substantially fixed.

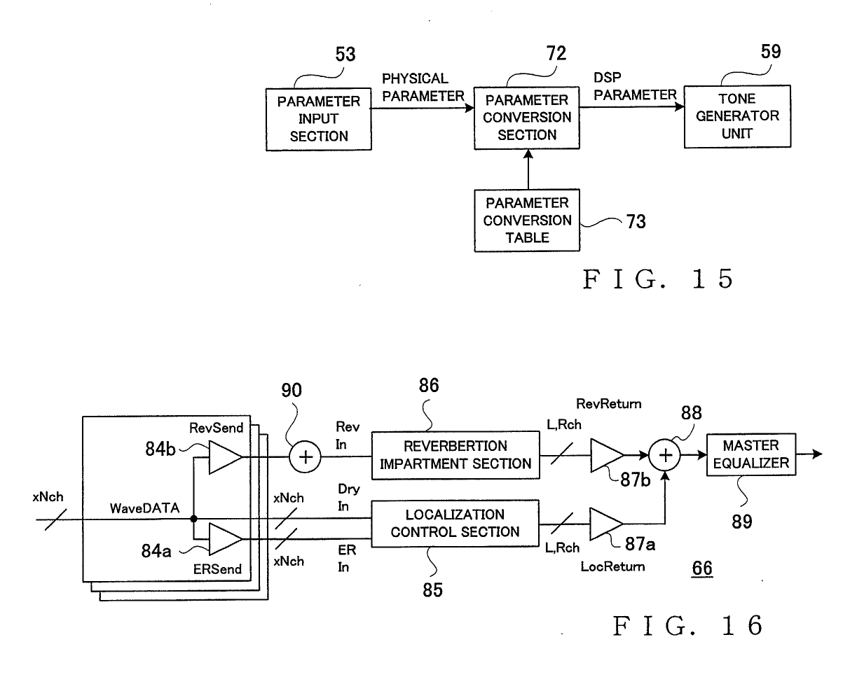

FIG. 13 is a conceptual diagram showing virtual speaker positions and virtual sound source position VP in the sound image localization apparatus in accordance with the second embodiment. In the illustrated example of FIG. 13, the four virtual speakers SP1-SP4 are provided at front left and right positions and rear left and right positions as viewed from the listener wearing the headphones. Direction of the sound source position VP is determined in accordance with sound volume level weighting among the virtual speakers SP1-SP4 around the listener's head. Sounds, delayed behind corresponding original sounds by time intervals in a range of several tens of milliseconds to ten-odd milliseconds, are generated from a position VP′ symmetric with respect to the sound source position VP about the position of the listener. Each of the sounds from the symmetric position VP′ supposes a reflected sound from a wall surface, and attenuation caused by the reflection is simulated by means of a later-described band-pass filter.

Distance of the sound source position VP is controlled on the basis of differences in level and arrival time lag among a direct sound (x), initial reflected sound (y) and reverberated sound (z). For example, the distance control based on the level differences is performed by gain coefficients included in parameters supplied by a DSP (Digital Signal Processor) to later-described multipliers. If the gain coefficient for the initial reflected sound is represented by “a” and the gain coefficient for the reverberated sound is represented by “b”, and when the sound source position VP is to be set close to the listener, the distance of the sound source position VP is controlled in such a manner that relationship of “x>ay+bz” can be established, i.e. that the level of the direct sound (x) becomes greater than the sum of the levels of the initial reflected sound (y) and reverberated sound (z). Further, when the sound source position VP is to be set remotely from the listener, the distance of the sound source position VP is controlled in such a manner that relationship of “x<ay+bz” can be established, i.e. that the level of the direct sound (x) becomes smaller than the sum of the levels of the initial reflected sound (y) and reverberated sound (z).

FIG. 14 is a block diagram showing an example of a basic general setup of the sound image localization apparatus in accordance with the second embodiment of the present invention. This sound image localization apparatus includes a bus 51, to which are connected a detection circuit 52, a display circuit 53, a RAM 54, a ROM 55, a CPU 56, an external storage device 57, a communication interface 58, a tone generator (T.G.) circuit 59 and a timer 60. User of this sound image localization apparatus can use an operator unit (input device) 62, connected to the detection circuit 52, to perform manual operations, for example, for inputting and selecting physical parameters and preset data, as will be later described in detail. For instance, the operator unit 62 may be of any suitable input device, such as a rotary encoder, mouse, keyboard, joystick controller, switch group, as long as it can produce an output signal in response to a user's input operation. A plurality of such input device may be connected to the detection circuit 52.

The display circuit 53 is connected with a display device 63 for visually displaying various information, such as the later-described physical parameters and preset numbers. The display device 63 in the illustrated example comprises a liquid crystal display (LCD) and light emitting diodes (LEDs), although the display device 63 may be of any other type as long as it can visually display various information. The external storage device 57 includes a dedicated interface, via which it is connected to the bus 51. The external storage device 57 may comprise one or more of a semiconductor memory such as a flash memory, floppy disk drive (FDD), hard disk drive (HDD), magneto-optical disk drive (MO), CD (Compact Disk)-ROM (Read-Only Memory) drive, DVD (Digital Versatile Disk) drive, etc. Data preset by the user, etc. can be stored in the external storage device 57 as necessary.

The RAM 54 includes flags, registers, buffers, and a working area for the CPU 56 to store various data. In the ROM 55, there can be stored preset data, function tables, various parameters, control programs, etc. In this case, the programs and the like need not be stored in the external storage device 57 in addition to the corresponding ones stored in the ROM 55. The CPU 56 carries out arithmetic operations and control in accordance with the control programs and the like stored in the ROM 55 or external storage device 57. Timer 60 is connected to the CPU 56 and bus 51, and it generates basic clock signals and signals indicative of interrupt process timing to be given to the CPU 56.

The tone generator circuit 59 generates tone signals in accordance with supplied MIDI signals and the like and outputs the thus-generated tone signals to the outside. In the illustrated example, the tone generator circuit 59 comprises a waveform ROM 64, a waveform readout device 65, a DSP (Digital Sound field Processor) 66 and a D/A converter (DAC) 67. The waveform readout device 65 reads out data of any of waveforms of various tone colors stored in the waveform ROM 64 under the control of the CPU 56. The DSP (Digital Sound field Processor) 66 imparts an effect, such as reverberation or sound image localization, to the waveform read out by the waveform readout device 65. The D/A converter 67 converts the waveform, imparted with the effect by the DSP 66, from digital representation to analog representation, and outputs the converted analog waveform to the outside. Functions of the DSP 66 will be later described more fully.

It should be appreciated that the tone generator circuit 59 may employ any other tone generation method than the memory readout method, such as the FM (Frequency Modulation) method, the physical model method, the harmonics synthesis method, the analog synthesizer method using a combination of VCO (Voltage Controlled Oscillator), VCF (Voltage Controlled Filter) and VCA (Voltage Controlled Amplifier). Further, the tone source circuit 59 may be implemented by a combined use of a DSP (Digital Signal Processor) and microprograms or of the CPU and software programs, rather than by use of dedicated hardware. In an alternative, the tone source circuit 59 may be implemented by a sound card.

The tone generation channels to simultaneously generate a plurality of tone signals in the tone source circuit 59 may be implemented by using a single or common tone generator circuit on a time-divisional basis, or by providing a plurality of tone generator circuit hardware in parallel so that each of the channels is implemented by a separate tone generator circuit.

The communication interface 58 is connectable to another musical instrument, audio equipment, computer or the like; the communication interface 58 is connectable at least to an electronic musical instrument. In this case, the communication interface 58 may be a general-purpose interface, such as a MIDI interface, RS-232C, USB (Universal Serial Bus) or IEEE 1394 interface.

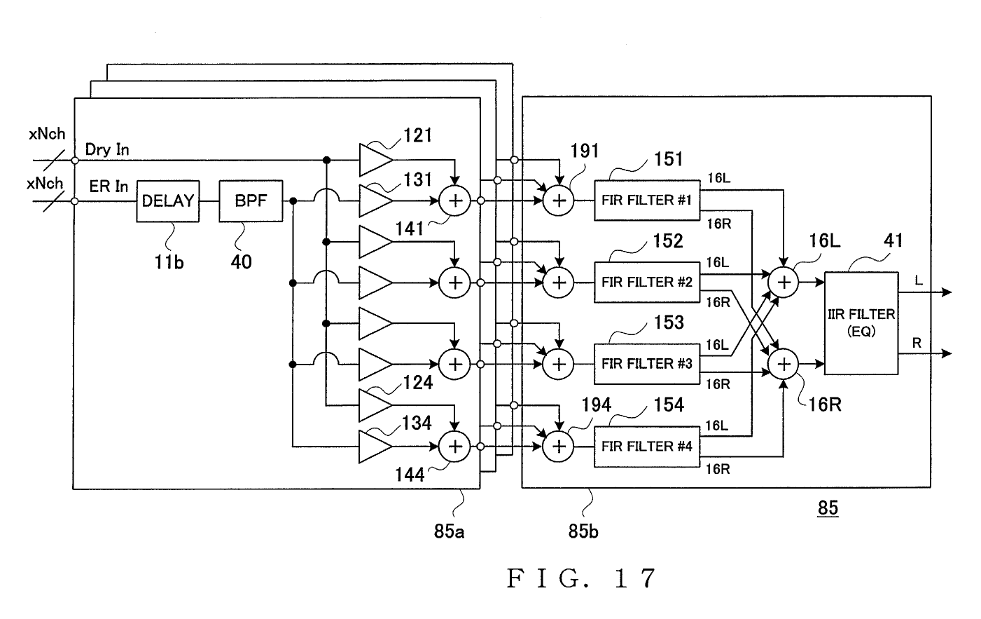

FIG. 15 is a block diagram conceptually showing a primary data flow in the second embodiment. Parameter input section 71 in this figure comprises, for example, a combination of the input device 62 and external storage device or ROM 55 of FIG. 14, and supplies various physical parameters to a parameter conversion section 72. Virtual space information and reproducing condition information are input to the parameter input section 71. These virtual space information and reproducing condition information is input by the user manipulating the input device 62 or selecting from among preset information. The virtual space information includes items of information indicative of a type and shape of a listening space in a hall, studio or the like and distance and direction of a virtual sound source as viewed from the listener. The reproducing condition information includes items of information indicative of personal data of the listener, characteristics of headphones used, etc. The thus-input virtual space information and reproducing condition information is passed to the parameter conversion section 72 as physical parameters.

The parameter conversion section 72 comprises, for example, the CPU 56 of FIG. 14, which converts the input physical parameters into various parameters for use by the DSP (hereinafter referred to as “DSP parameters”). The conversion of the physical parameters into the DSP parameters is made by reference to a parameter conversion table 73. The parameter conversion table 73 is provided in the external storage device 57 or ROM 55 of FIG. 14. The DSP parameters include filter coefficients to be used by a localization control section 85 of FIG. 16 for controlling FIR filters 15, IIR filters 41, gain coefficients to be used by the localization control section 85 for controlling various multipliers, delay times of a delay circuit 11b etc., as well as various parameters for controlling a reverberation impartment section 86. The converted DSP parameters are supplied to a tone generator unit (tone generator circuit) 59, which in turn imparts any of various effects to waveform data on the basis of the input DSP parameters and outputs the effect-imparted waveform data as a tone signal. Note that the DSP parameters are not limited to those obtained by converting the physical parameters, and may be prestored as preset parameters for each localization pattern, reverberation pattern or each combination of these patterns.

FIG. 16 is a block diagram showing the functions of the DSP 66 shown in FIG. 14. The DSP 66 includes the multipliers 84, localization control section 85, reverberation impartment section 86, multiplier 87, adders 88 and 90, and master equalizer 89. Once the waveform data for a plurality of channels (xNch) read out by the waveform readout device 65 of FIG. 14, the waveform data for each of the channels are divided into three data, i.e. waveform data representing to a direct sound, initial reflected sound and reverberated sound. The waveform data representing the direct sound for the plurality of channels (xNch) are passed directly to the localization control section 85 as data DryIn. The waveform data representing the initial reflected sound for the plurality of channels (xNch) are multiplied via the multiplier 84a by gain coefficients determined on the basis of the set distance between the listener and the virtual sound-generating position, and then passed to the localization control section 85 as data ERIn. Further, the waveform data representing the reverberated sound for the plurality of channels (xNch) are multiplied via the multiplier 84b by gain coefficients determined on the basis of the set distance between the listener and the virtual sound-generating position, added together via the adder 90 and then passed to the reverberation impartment section 86 as data Rev1n. As will be later described in detail with reference to FIG. 17, the localization control section 85 controls the virtual sound-generating position.

The reverberation impartment section 86 imparts reverberations to the input waveform data to create a feel of distance of the virtual sound source and also simulate a virtual space, and outputs the reverberation-imparted waveform data as reverberated sounds. Pattern of the reverberated sounds differs in reverberation time, level difference between the direct sound and the initial reflected sound and attenuation amount per frequency band, depending on the type of the listening space. These reverberation time, level difference between the direct sound and the initial reflected sound and attenuation amount per frequency band are input as the DSP parameters. Although these DSP parameters have been described as generated by converting the user-input physical parameters, they may be stored as preset parameters in association with possible types of listening spaces, such as a hall and studio. The waveform data output from the localization control section 85 and reverberation impartment section 86 are multiplied via the corresponding multipliers 87a and 87b, and then additively synthesized via the adder 88 to generate single waveform data. The thus-generated single waveform data is transferred to the master equalizer 89, which in turn compensates frequency characteristics of the input waveform data and outputs the thus-compensated waveform data to the DAC 67 of FIG. 14.

FIG. 17 is a functional block diagram of the localization control (LOC) section 85 shown in FIG. 16. The localization control section 85 includes a plurality of preceding stage sections 85a corresponding to the plurality of channels (xNch), and a single succeeding stage section 85b. The localization control section 85 of FIG. 17 is substantially similar in basic construction to the localization control section of FIG. 3 employed in the first embodiment of the sound image localization apparatus, except that the localization control section 85 of FIG. 17 has a plurality of inputs, the number of the channels is smaller, and so on. Elements having the same functions as those in FIG. 3 are denoted by the same reference numerals as in the figure.

Each of the plurality of preceding stage sections 85a has an input DryIn for the waveform data representing the direct sound, and an input ERIn for the waveform data representing the initial reflected sound. The waveform data input through the input DryIn is divided into four channels corresponding to the front left and right and rear left and right directions, and then the divided waveform data are passed to corresponding multipliers 121-124 for multiplication by gain coefficients having been input as the DSP parameters. After the multiplication via the corresponding multipliers 121-124, the waveform data are passed to corresponding adders 141-144.

The waveform data input through the input ERIn is passed to a delay circuit 11b where it is delayed behind the direct sound by a delay time in a range of several tens of milliseconds to ten-odd milliseconds, and the thus-delayed data is delivered as an initial reflected sound to a band-pass filter (BPF) 40. The band-pass filter (BPF) 40 is provided for simulating attenuation caused by the reflection and imparting such attenuation to the initial reflected sound. After that, the initial reflected sound is divided into four channels corresponding to the front left and right and rear left and right directions, and then the divided waveform data are passed to corresponding multipliers 131-134 for multiplication by gain coefficients having been input as the DSP parameters. After the multiplication via the corresponding multipliers 131-134, the waveform data are passed to the corresponding adders 141-144. The adders 141-144 each additively synthesize the direct sound and initial reflected sound and sends the additively-synthesized result to a corresponding one of adders 191-194.

Each of the FIR filters 151-154 includes filters 15L and 15R for left and right ears provided in parallel with each other. The left-ear filter for the channel Ch1 simulates, in accordance with the head related transfer function, a sound when a particular tone arrives at the left ear from the front left direction of FIG. 13, and the right-ear filter for the channel Ch1 simulates, in accordance with the head related transfer function, a sound when the tone arrives at the right ear from the front left direction of FIG. 13. Similarly, the FIR filters for the other channels Ch2-Ch4 include filters 15L and 15R for left and right ears, which simulate, in accordance with the head related transfer functions, transfer of a tone when the tone arrives at the left and right ears from the front left and right and rear left and right directions, respectively.

If the virtual sound-generating position is intermediate between two of the above-mentioned basic directions, angles defined between the virtual sound-generating position and the two basic directions are calculated, and delay times and gain coefficients are given to the delay circuit lib and the gain multipliers 121-124 and 131-134 for the individual channels.

The left and right waveform data output from the FIR filters 151-154 for the individual channels are additively synthesized through left and right adders 16L and 16R, respectively. The thus additively-synthesized digital tone signals (waveform data) are passed to an IIR filter 41 having a pair of left and right channels. Similarly to the IIR filter 41 in the first embodiment of FIG. 3, the IIR filter 41 of FIG. 17 functions to compensate characteristics of the additively-synthesized digital tone signals (waveform data). The waveform data thus compensated by the IIR filter 41 are output to the multiplier 87a of FIG. 16.

Because the above-described second embodiment accomplishes the HRTF reproduction by means of the impulse-response superposing (or convoluting) FIR filters and the frequency-characteristic compensating IIR filter following the FIR filters, the digital tone signals can be compensated in accordance with differences in tastes or preference between individual listeners and in localization characteristics. Further, because HRTFs corresponding to the differences in tastes or preference between the individual listeners and in localization characteristics can be preset, settings for the HRTF reproduction can be made with utmost ease. Further, various types of sound image localization including reverberations can be prestored as preset patterns, any desired one of which can be selected by the user.

Further, with the above-described arrangements, fixed coefficients can be applied to the FIR and IIR filters irrespective of each sound image localization point, and it is possible to allow a number of separate sound sources to be localized with a small-scale construction by just providing a particular number of the preceding stage sections 85a corresponding to the number of the input lines and sharing the succeeding stage section 85b among the individual lines as shown in FIG. 17. Namely, in the second embodiment, the input adders 191-194 of the preceding stage section 85b add together the corresponding signals supplied from the preceding stage section 85a for each of the input line.

Whereas the embodiments of the present invention have been described above in relation to the case where the listener listens to sounds using headphones, the present invention can also be applied when the listener listens to sounds from speakers, by providing a crosstalk canceler at a stage succeeding the IIR filter 41 of FIG. 3 or 17.

Further, the embodiments of the present invention may be practiced on a commercially-available computer having installed therein software programs etc. corresponding to the embodiments. In such a case, the software programs etc. corresponding to the embodiments may be stored in a computer-readable storage medium, such as a CD-ROM or floppy disk, and supplied to any interested users in the storage medium. Where such a general-purpose computer or other type of computer is connected to a communication network such as a LAN, the Internet and/or telephone line network, any necessary computer program and various data may be supplied to the general-purpose computer or other type of computer via the communication network.

Further, the above-described embodiments of the present invention may be practiced not only by a single apparatus but also a plurality of apparatus interconnected via MIDI interfaces and communication facilities such as a communication network. Furthermore, the above-described embodiments of the present invention may be practiced by an electronic musical instrument containing a tone generator device, automatic performance device, etc. within the body of the musical instrument. The electronic musical instrument used for this purpose may be of any desired type, such as a keyboard, stringed, wind and percussion type.

It should be obvious to those skilled in the art that the present invention is not limited to the above-described embodiments and various modifications, improvements, combinations are also possible without departing from the basic principles of the invention.

In summary, the present invention arranged in the above-described manner achieves sufficient realism in sound listening by headphones. Further, the present invention can selectively adjust an effect corresponding to an installed location of a musical instrument and a type of a listening space, and can also store the adjusted effect in memory. Furthermore, the present invention can adjust a feeling of localization for each listener and for each type of headphones used, and can also store the adjusted feeling of localization in memory.

What is claimed is:

1. A sound image localization apparatus for receiving an input tone signal and localizing a sound image of the tone signal in a given position, said sound image localization apparatus comprising
a plurality of filter units provided in corresponding relation to a plurality of different predetermined directions on a one-to-one basis, each of said filter units processing the tone signal with predetermined transfer characteristics peculiar to the predetermined direction corresponding thereto.

2. A sound image localization apparatus as claimed in claim 1 wherein each of said filter units processes the tone signal with transfer characteristics for simulating transfer of a sound from the corresponding predetermined direction to left and right ears of a human listener, and thereby outputs processed tone signals corresponding to the left and right ears.

3. A sound image localization apparatus as claimed in claim 1 which further comprises a filter for compensating frequency characteristics of the tone signals output from said filter units.

4. A sound image localization apparatus as claimed in claim 1 which further comprises a level controller that separately controls respective levels of tone signals to be input to or output from said plurality of filter units, to thereby vary sound image localization.

5. A sound image localization apparatus as claimed in claim 1 which further comprises a reflected-sound-signal generation section that generates a reflected sound signal on the basis of the tone signal.

6. A sound image localization apparatus as claimed in claim 5 wherein said reflected-sound-signal generation section includes a delay section that generates an initial reflected sound signal on the basis of delaying the tone signal, and a filter that generates an attenuated reflected sound signal on the basis of filtering the initial reflected sound signal.

7. A sound image localization apparatus as claimed in claim 5 which further comprises a controller that separately controls a level of the tone signal as a direct sound signal and a level of the reflected sound signal generated by said reflected-sound-signal generation section and then supplies the direct sound signal and the reflected sound signal having been controlled in level to individual ones of said filter units, the levels of the tone signal as the direct sound signal and the reflected sound signal being controlled by said controller independently for each of said filter units.

8. A sound image localization apparatus as claimed in claim 1 which further comprises:
a signal generator section that, on the basis of the input tone signal, generates a direct sound signal and a reflected sound signal delayed behind the direct sound signal; and
a level controller that controls a level of the direct sound signal and a level of the reflected sound signal and then supplies the direct sound signal and the reflected sound signal having been controlled in level to individual ones of said filter units, the levels of the direct sound signal and the reflected sound signal being controlled by said level controller independently for each of said filter units.

9. A sound image localization apparatus as claimed in claim 1 which further comprises a reverberated-sound generation section that generates a reverberated sound on the basis of the tone signal.

10. A sound image localization apparatus as claimed in claim 2 which further comprises:
headphones that audibly reproduces the processed tone signals corresponding to the left and right ears;
a detector that detects movement of said headphones; and
a level controller that separately controls respective levels of tone signals to be input to individual ones of said plurality of filter units independently of each other, and
wherein said level controller controls the respective levels of the tone signals to be input to the individual filter units in accordance with an output of said detector.

11. A sound image localization method for receiving an input tone signal and localizing a sound image of the tone signal in a given position, said sound image localization method comprising
a step of performing a plurality of filtering processes on the tone signal in a parallel fashion, said plurality of filtering processes being set in corresponding relation to a plurality of different predetermined directions on a one-to-one basis, each of said filtering processes processing the tone signal with predetermined transfer characteristics peculiar to the predetermined direction corresponding thereto.

12. A sound image localization method as claimed in claim 11 wherein each of said filtering processes performed by said step of performing processes the tone signal with transfer characteristics for simulating transfer of a sound from the corresponding predetermined direction to left and right ears of a human listener, and thereby outputs processed tone signals corresponding to the left and right ears.

13. A sound image localization method as claimed in claim 11 which further comprises a step of performing a filtering process for compensating frequency characteristics of the tone signals having been subjected to said plurality of filtering processes by said step of performing.

14. A sound image localization method as claimed in claim 11 which further comprises a step of separately controlling respective levels of tone signals to be subjected to or having been subjected to said plurality of filtering processes by said step of performing, to thereby vary sound image localization.

15. A sound image localization method as claimed in claim 11 which further comprises:
a step of generating, on the basis of the input tone signal, a direct sound signal and a reflected sound signal delayed behind the direct sound signal; and
a level control step of controlling a level of the direct sound signal and a level of the reflected sound signal to generate input signals to be supplied to individual ones of said filtering processes, the levels of the direct sound signal and the reflected sound signal being controlled independently for each of said filtering processes.

16. A machine-readable storage medium containing a group of instructions to cause said machine to perform a sound image localization method for receiving an input tone signal and localizing a sound image of the tone signal in a given position, said sound image localization method comprising
a step of performing a plurality of filtering processes on the tone signal in a parallel fashion, said plurality of filtering processes being set in corresponding relation to a plurality of different predetermined directions on a one-to-one basis, each of said filtering processes processing the tone signal with predetermined transfer characteristics peculiar to the predetermined direction corresponding thereto.

17. A machine-readable storage medium as claimed in claim 16 wherein each of said filtering processes performed by said step of performing processes the tone signal with transfer characteristics for simulating transfer of a sound from the corresponding predetermined direction to left and right ears of a human listener, and thereby outputs processed tone signals corresponding to the left and right ears.

18. A machine-readable storage medium as claimed in claim 16 which further comprises a step of performing a filtering process for compensating frequency characteristics of the tone signals having been subjected to said plurality of filtering processes by said step of performing.

19. A machine-readable storage medium as claimed in claim 16 which further comprises a step of separately controlling respective levels of tone signals to be subjected to or having been subjected to said plurality of filtering processes by said step of performing, to thereby vary sound image localization.

20. A machine-readable storage medium as claimed in claim 16 which further comprises:
a step of generating, on the basis of the input tone signal, a direct sound signal and a reflected sound signal delayed behind the direct sound signal; and
a level control step of controlling a level of the direct sound signal and a level of the reflected sound signal to generate input signals to be supplied to individual ones of said filtering processes, the levels of the direct sound signal and the reflected sound signal being controlled independently for each of said filtering processes.

21. A computer program comprising computer program code means for performing all the steps of claim 11 when said program is run on a computer.

22. A computer program comprising computer program code means for performing all the steps of claim 13 when said program is run on a computer.
